(19) United States
(12) Patent Application Publication
(10) Pub. No.: US 2012/0047364 A1
(43) Pub. Date: Feb. 23, 2012

(54) SYSTEM AND METHODS FOR PROVIDING DATA SECURITY AND SELECTIVE COMMUNICATION

(76) Inventors: Matt Levy, Encinitas, CA (US); Robert Wong, San Diego, CA (US)

(21) Appl. No.: 12/860,803

(22) Filed: Aug. 20, 2010

(51) Int. Cl. H04L 29/06

(52) U.S. Cl. 713/166

(57) ABSTRACT

Systems and methods for providing data security and selective communication are provided in which a classified communication is received and processed for retransmission to a recipient having a different clearance authorization than that associated with the communication. The retransmitted data includes a subset of data that is selected based on predetermined criteria, and is determined automatically by a guard application, such that the retransmitted information is properly sanitized.

### I. STATEMENT REGARDING FEDERALLY SPONSORED RESEARCH OR DEVELOPMENT

The United States Government may have certain rights in this invention pursuant to SBIR Contract FA8750-09-C-0108 awarded by the United States Air Force.

### II. FIELD OF THE INVENTION

This invention relates to data security and the selective authorization of information for communication. The invention may be well-suited for use in environments in which it is desirable to remove non-necessary information from electronic data prior to communicating the sanitized information, such as in a governmental or military communication network and particularly those involving airborne cross domain solutions.

### III. BACKGROUND OF THE INVENTION

Vast amounts of data are communicated electronically and access to such data can reveal a wealth of information. In some situations, such as when sharing information derived from fundamental scientific research, it may be desirable to offer unfettered access to the information. In many other situations, there may be reasons to limit access to the electronically-communicated data. For example, in military or governmental settings, access to certain information may be restricted by document classification, which requires proper clearance or “need to know” authority to access. Likewise, privacy issues may limit the desired accessibility of medical records, financial information, personal information, and other such data.

There are a number of known systems and methods for restricting access to electronic data and for communicating electronic data. These restrictions include physical barriers (such as maintaining the information in a locked compartment) and electronic access controls (such as password protections). These known methods face a number of limitations that make the restrictions undesirable for some applications. Physical barriers may limit access to the information to those entities in physical proximity to where the information is stored. As a result, physical barriers may not be useful for accessing information that is intended to be communicated to a remote party. Likewise, electronic access controls, such as passwords, are susceptible to hacking or compromise, thereby allowing an unscrupulous user to have access to the protected information. Moreover, the utilization of access controls may limit the speed at which information may be communicated.

Access to some types of information should be limited. For example, hospitals and workers in the medical environment must maintain patient confidentiality under HIPAA, banks and other financial institutions safeguard their client's financial records, and the general population may be wise to protect their personal identifiable information. Likewise, certain users have specialized requirements for the handling of electronic information, such as the United States Government, which has developed a document classification system.

The United States governmental classification system includes a number of different classification levels, including RESTRICTED, CONFIDENTIAL, SECRET, TOP SECRET, and NO FOREIGN DISSEMINATION (NOFORN). The degree of clearance of these classifications may be compared to one another, such that “TOP SECRET” offers a greater, or “higher,” degree of authorization to access information than does “SECRET.”

In some instances it may be desirable to communicate certain information in a TOP SECRET document to a warfighter on the battlefield. If that warfighter does not have TOP SECRET clearance, non-necessary information may require removal from the document (also known as “stripping,” “cleaning,” or “sanitizing”) and the resultant information may be communicated to the warfighter as TACTICAL UNCLASSIFIED INFORMATION (TUI) so that she may use the information to complete her mission. In these instances, time is often critical so it is desirable to quickly strip the unnecessary information from the original document and communicate the TUI to the warfighter as rapidly as possible.

Known systems of communicating information may be slow and cumbersome. For example, one method of communicating classified information is to type the information into a document having numbered paragraphs, wherein each paragraph is provided with an individual classification level. The document as a whole is provided with a security level greater than or equal to that of the highest security level of the paragraphs. Then, if the document is communicated to an individual having a lower clearance level than the document's classification level, the document may be cleaned by removing all paragraphs having a higher classification level that the individual is cleared for prior to communication to that individual.

Other known systems of communication involve human intervention in order to remove data. For example, if a communication is not in a format wherein it is written in numbered paragraphs, each having its own security level, a security specialist may have to manually review the communication and manually identify and remove the portions that should be withheld from the recipient. This procedure may be extremely time-consuming and my not be desirable by a warfighter who is relying on communication of rapidly-developing information in a tactical environment.

Efforts to overcome the drawbacks of the above-described systems have included the implementation of multiple levels of security (MLS), which is a computerized system allowing communication of information between environments having different security levels. While transfer of documents and information from a lower-to-higher security level is relatively simple, difficulties arise in the transfer of information from a higher-to-lower security level. In this regard, the MLS technologies approved for government use typically employ strict compliance with certain rules to sanitize the communicated information, and therefore leave little to no subjective or discretionary communication of information. While such systems provide a high degree of security, they lack the ability to be flexible enough to allow for a quick downgrade of information absent human intervention and review.

An architecture that may be used in a multilevel security environment is known as multiple independent levels of security (“MILS”). MILS architecture involves isolation of each level of classification within its own single-level environment. Examples of a MILS-based systems are the VxWorks MILS Platform offered by Wind River of Alameda, Calif., LynxSecure offered by LynuxWorks of San Jose, Calif., and INTRGRITY-178 offered by Green Hills Software of Santa Barbara, Calif. Such systems may divide a computing system into a number of partitions that are separated from one another by space and time resource allocation. Nevertheless, MILS architecture typically does not recognize the hierarchical structure that is used in the United States' governmental security classification system, and therefore is limited for use in such an environment.

Cross-domain solutions attempt to address the deficiencies of MLS and provide communications between environments of different security levels. Cross-domain solutions (“CDS”) may include both automated processes and those involving human intervention and typically involve concepts of risk-management in assessing the benefits of sharing protected information with the risks that the protected information may be revealed. CDS approaches vary in complexity from simple automated systems of limited cleansing ability to complex systems involving a plurality of human reviewers. One example of a CDS is Radiant Mercury offered by Lockheed Martin. Another example is the Information Support Server Environment (ISSE) Guard offered by International Telephone and Telegraph of White Plains, N.Y. One of the drawbacks of the implementation of these CDS systems in a military environment is the weight and size of the necessary hardware. Because these systems typically involve a number of hardware components to provide separate networks, it has a high operating cost in terms of space, weight and power (SWAP). Other drawbacks of CDS approaches include the increased risk of inadvertent disclosure of information and the increased implementation costs as compared to MLS. Also, as with other known systems, the CDS approach faces limitations in providing rapid communication of information culled from data having multiple security levels absent the need for human intervention.

For military applications, there is a need for a reliable, secure, system that allows timely sharing of data across U.S. security domains. In particular, there is a need for such a system that can operate in an airborne environment, yet involves low risk of inadvertent disclosure of data. Such a system should be able to be accredited and remain versatile enough to meet the warfighter's operational needs. There is further a need for such a system on an airborne platforms that enables expeditious sharing of time-critical information among tactical forces. The operating environments of airborne platforms are manpower-limited, require low operator overhead, are SWAP constrained and require the ability to share information across multiple security domains without having to rely on authorization from ground-based release points. Specific needs also include assured information sharing in the military from SECRET to TACTICAL UNCLASSIFIED INFORMATION security levels.

In view of the foregoing, previously-known information sharing and communication systems and methods have a number of disadvantages which limit use of such systems in environment used by the military, law enforcement, homeland security, and other entities that share confidential or protectable time-sensitive information.

In particular, there exists a need for systems and methods for managing the communication of data wherein the information can be quickly downgraded and communicated.

It further would be desirable to provide systems and methods for managing the communication of data in an airborne environment while reducing the costs of space, weight and power as compared to known systems.

Additionally, it would be desirable to provide systems and methods for managing the communication of data that involves a low risk of inadvertent disclosure of data.

It further would be desirable to provide systems and methods for managing the communication of data that lend themselves to governmental accreditation.

It is also desirable to provide systems and methods for managing the communication of data which meet the warfighter's needs of a rapid sanitation of SECRET data and communication of the resulting TACTICAL UNCLASSIFIED INFORMATION data.

It is further desirable to provide systems and methods for managing the communication of data which can operate with minimal human intervention.

### IV. SUMMARY OF THE INVENTION

The present invention is directed to systems and methods of communicating electronic data that are advantageous for use by the military, law enforcement, homeland security, and similar entities. The systems and methods of the present invention advantageously allow for quick downgrading and communication of information and are appropriate for use in an airborne environment. Moreover, as the invention may be practiced on systems smaller than known communication systems, it may be appropriate for use in unmanned aerial vehicles (UAVs) in which SWAP considerations play a key role in determining the available communication systems. The systems and methods of the present invention also involve a low risk of inadvertent data disclosure and are suitable for government accreditation. Moreover, the systems and methods of the present invention meet the warfighter's needs of a rapid sanitation of SECRET data and communication s of the resulting TACTICAL UNCLASSIFIED INFORMATION data with minimal human intervention.

In accordance with one aspect of the present invention, a system for providing data security and allowing selective communication of electronic data is provided in which a specialized computer system has a memory that is divided into a plurality of partitions, wherein at least some of the partitions are assigned different classification levels. Communications applications operate in at least two partitions having different classification levels. Electronic information may be passed from the partition with the higher classification to the partition with the lower classification via a unidirectional communication path defined by a separation kernel. The system also includes a guard application configured to examine the information and filter out data that is not appropriate for transfer from a higher classified partition to a partition of lower classification level. After a communication application receives data having a high classification level, the guard examines the data and filters out information that is not appropriate for transfer to a partition having a lower classification. The information that survives the filtration process may then be communicated to the communication application in the partition having a lower classification level. The communication application may then transmit the filtered information externally.

In application, an embodiment of the present invention may be mounted on a UAV that is operating in a warzone. The UAV may receive TOP SECRET information via a communications application in a TOP SECRET partition. A guard examines the TOP SECRET information and determine a subset of that information that is appropriate to communicate to a warfighter having only a SECRET clearance authorization. That subset of information is then communicated from the TOP SECRET partition to a SECRET partition, and then a communication application in the SECRET partition transmits the subset of information to the warfighter. In a preferred embodiment, this process occurs with little to no significant delay, and can be considered to occur in real time. Accordingly, the warfighter can access selected information from a higher classification than she is authorized without undue delay or human intervention.

In some preferred embodiments, a system for managing the selective communication of electronic data comprises a memory device, a processor, a separation kernel, a guard application, and first and second communication applications. The memory device has volatile memory and non-volatile memory, the volatile memory having a first partition with a first classification level and a second partition with a second classification level, the second classification level being lower than the first classification level. The processor is in communication with the first the second partitions and is configured to control transfer of data from the first partition to the second partition via a unidirectional communication path provided by the separation kernel, which is stored in the non-volatile memory. In addition to providing unidirectional paths between the partitions, the separation kernel is provides operating environments in the first and second partitions. The first and second communication applications operate in the operating environments of the first and second partitions, respectively. The guard application is stored in the non-volatile memory and is configured to examine the data received by the first communication application and determine a subset of that data which is authorized for communication from the first partition to the second partition, where the second communication application may then transmit the subset of data to a remote recipient.

In some of these embodiments, the guard is configured to operate in the operating environment of the first partition. In other embodiments, the guard is configured to operate in the operating environment of the second partition. In yet other embodiments, there is a third partition and the guard is configured to operate in an operating environment of the third partition.

In other preferred embodiments, a system for managing the selective communication of electronic data comprises a memory device, a processor, a separation kernel, a guard application, and first and second communication applications, wherein the memory device has at least four partitions. A first set of two of the partitions has a first classification level and a second set of two of the partitions have a second classification level different from the first. In each of these sets, one partition is configured to have an operating system in which a communication applications operates. The processor is in communication with the partitions is configured to control communication of data between the partition via unidirectional communication pathways provided by the separation kernel. The guard application is stored in the non-volatile memory and is configured to examine the data received by the first communication application and determine a subset of that data which is authorized for communication from the first partition to another partition where is may be transmitted to a remote recipient. In some these embodiments, there are multiple guard applications, and the sets of two partitions contain one partition with a communication application and one partition with a guard application. Methods of using the inventive data communication system also are provided.

### V. BRIEF DESCRIPTION OF THE DRAWINGS

FIG. 1 is a schematic representation of an exemplary embodiment of the present invention.

FIG. 2 is a schematic view of the arrangement of the components of the exemplary system of FIG. 1.

FIG. 3 is a schematic view of a first exemplary implementation of the systems of the present invention.

FIG. 4 is a schematic view of an alternative exemplary implementation of the systems of the present invention.

FIG. 5 is a schematic view of a further alternative exemplary implementation of the systems of the present invention.

FIG. 6 is a flow chart illustrating a method of using the present invention.

FIG. 7 depicts a schematic representation illustrating use of methods of the present invention.

### VI. DETAILED DESCRIPTION OF THE INVENTION

The present invention provides electronic data communication systems and methods of use thereof, suitable for use in tactical military environments wherein classified data must be quickly downgraded and communicated to the warfighter or other entity. Preferred embodiments of the invention may be utilized in UAVs or other airborne platforms for reception of classified information and rebroadcast of a subset of that information to warfighters having a lower clearance level. Of course, the invention is not limited to use in such environments, and may be utilized for communicating other types information especially wherein filtering of the information to a downstream recipient is desired.

Communication systems in accordance with the present invention may be utilized in a static environment, such as a land-based system, or a dynamic environment, such as an air-based system. Advantageously, the system may be constructed so as to be extremely small and compact, as compared to previously-known systems. Accordingly, the savings of size, weight and power required to operate and house the system make it extremely adaptable to implementation in UAVs and other small airborne systems.

Additionally, systems in accordance with the present invention are extremely secure. In preferred embodiments of the invention, the system has a memory having volatile and non-volatile memory. Communication programs and device drivers are stored in the non-volatile memory, whereas those programs operate in environments existing in the volatile memory. Incoming data that is received by the system is processed and analyzed in operating environments in the volatile memory, and resultant filtered data is also resident in the volatile memory prior to communication to a downstream recipient. Once processed and analyzed, the data preferably is no longer stored in the memory. Therefore, if the device of the present invention is obtained by an adversary, it would not contain any of the classified information that was received or transmitted.

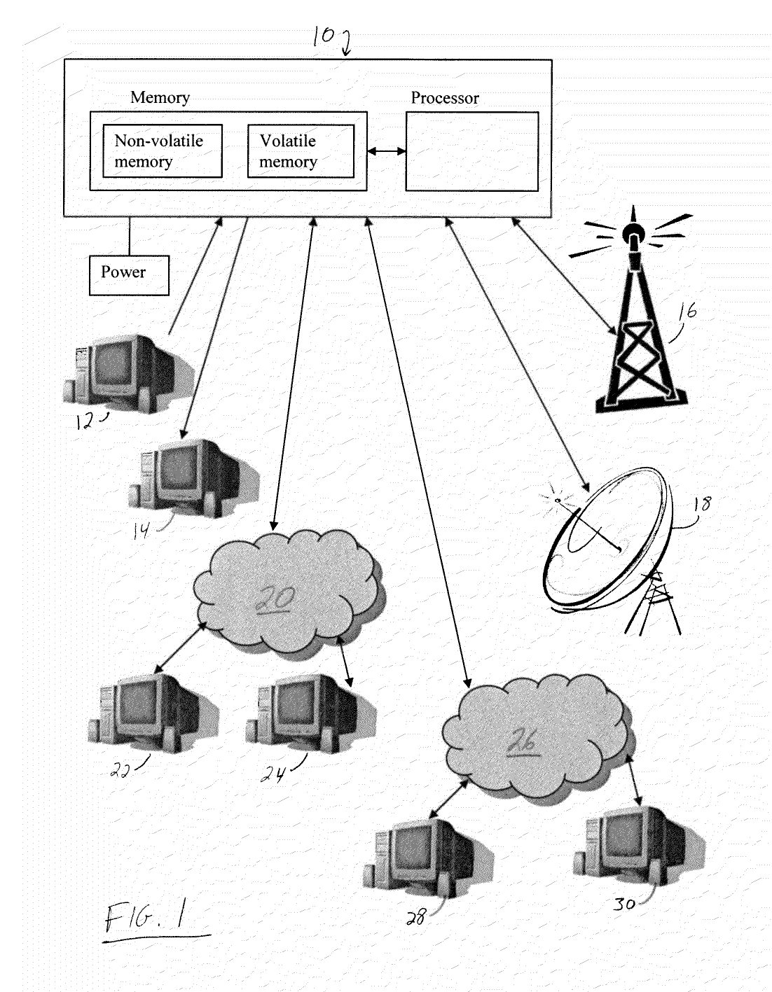

Referring to FIG. 1, an embodiment of the present invention is described that interacts with multiple communication systems and devices. System 10 communicates with computer 12, computer 14, antenna 16, antenna 18, network 20, which further connects computers 22 and 24, and network 26, including computers 28 and 30. It will be appreciated that networks 20 and 26 may be in different environments and may include local networks, the civilian Internet, and the U.S. Government's Secret Internet Protocol Router Network (SIPRNet) among others. As such, data may be received via one system and may then be processed and transmitted via another system. For example, data that is classified as SECRET may be received via SIPRNet via network 20 and system may then retransmit the same data over a secure transmission via antenna 18 and may also process the data to extract tactical classified information which may be transmitted to a warfighter via antenna 16. A local operator may monitor the data transmissions via computer 12. One of skill in the art will appreciate that other communications systems may be employed in conjunction with the present invention to transmit and/or receive data.

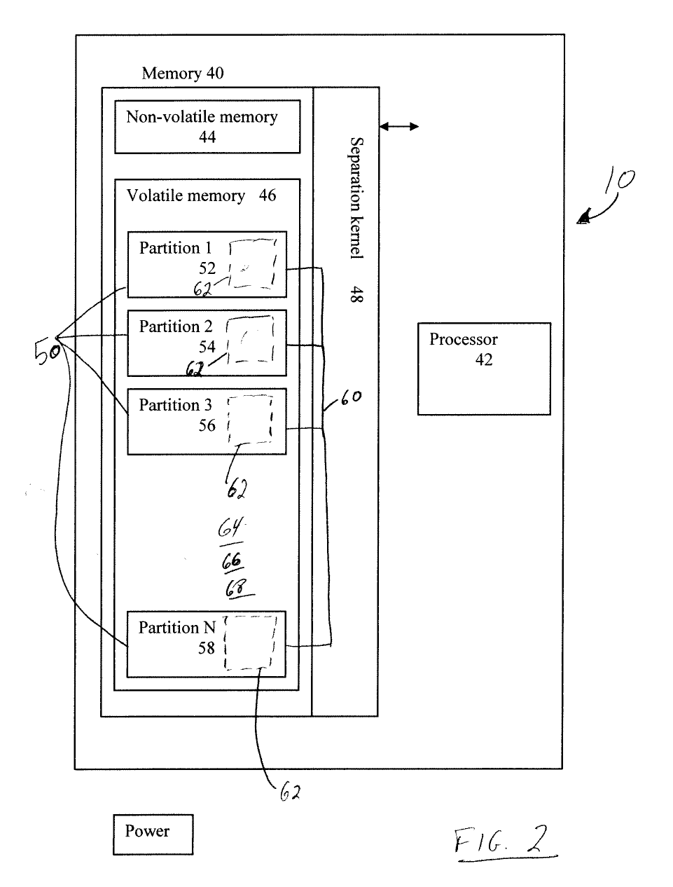

Referring now to FIG. 2, system 10 includes memory 40 in communication with processor 42. Memory 40 includes non-volatile memory 44 and volatile memory 46. Non-volatile memory 44 preferably comprises ROM, flash memory, magnetic storage, optical disc or other known storage device. Volatile memory 46 preferably comprises RAM, DRAM, SRAM or other known temporary memory. Volatile memory 44 is in communication with non-volatile memory 46. Processor 42 preferably is an integrated circuit microchip but may be a central processing unit or other processor.

System 10 also includes separation kernel 48, preferably a MILS separation kernel, stored in non-volatile memory 44. Separation kernel 48 is a low level operating system that preferably contains less than 5,000 lines of source code, and more preferably less than 4,000 lines. Separation kernel 48 preferably enforces four basic security policies: data isolation (space partitioning), periods partitioning (time partitioning), information flow and fault isolation.

Separation kernel 48 allows division of volatile memory 46 into a plurality of partitions 50, including partition 52, partition 54, partition 56 and partition 58. Partitions 50 are separated by space and time to avoid unwanted “leakage” of data from one partition to another, and therefore accomplish data isolation of their contents. Partitions 50 need not all have the same classification level and preferably have different classification levels, such as SECRET, TOP SECRET, TACTICAL CLASSIFIED INFORMATION, UNCLASSIFIED, and the like. System 10 may be further configured to include partitions 50 having both United States Government classification levels as well as those with classification levels of foreign governments so that system 10 may be used by joint coalition forces operating in the same theater while still maintaining the protection of each country's classified information.

Separation kernel 48 allows configuration of unidirectional communication paths 60 between partitions 50. For example, unidirectional path 62 provides a communication path for data from partition 52 to partition 54, but does not allow communication of the information to any other partition, nor does it allow any partition to communicate with partition 52. Control of information flow via the unidirectional communication paths 60 is controlled by processor 42.

Separation kernel 48 also provides operating environments 62 in each of partitions 50, such that computer software programs may be separately operated in each partition. Programs that may be desirable in system 10 include a guard application 64, middleware (device drivers), and communication applications 66 (such as e-mail, chat, file transfer protocol, and command and control (“C2”)), among others. Each of the computer software programs need not be operating in every partition, but in some cases it may be desirable to have a program operate in multiple partitions. For example, in some embodiments guard application 64 may operate in a single partition, wherein in other embodiments guard application 64 may operate in each of partitions 50. Examples of separation kernels that may be adapted for use in the present invention include INTEGRITY® and INTEGRITY®-178B available from Green Hills Software, LynxSecure available from LynuxWorks, and VxWorks MILS and VxWorks 653 available from Wind River Corporation. See, U.S. Pat. No. 7,103,745 to Koning, et al., entitled “Two-level operating system architecture,” which is incorporated by reference in its entirety.

Guard application 64 is stored in non-volatile memory 44 and may operate in one or more of operating environments 62. Guard application 64 is a cross domain solution program that enables the secure transfer of information across different security enclaves, for example TOP SECRET/SCI to SECRET GENSER or SECRET/NOFORN to UNCLASSIFIED. Guard application 64 collates, downgrades, and encrypts information so that it can be communicated between partitions having different security classifications. Known guard applications include Radiant Mercury™ available from Lockheed Martin, the Information Support Server Environment (ISSE) system available from International Telephone and Telegraph, and DataSync Guard 4.0 available from British Aerospace Engineering. The design and use of guards are known to those of skill in the art. Likewise, other information may be found in U.S. Pat. No. 6,834,382 to Marso, et al., entitled “Message parser and formatter,” U.S. Pat. No. 7,293,175 to Brown, et al., entitled “Automatic information sanitizer,” U.S. Pat. No. 7,437,408 to Schwartz, et al., entitled “Information aggregation, processing and distribution system,” U.S. Pat. No. 7,676,673 to Weller, et al., entitled “Multi-level secure (MLS) information network,” and U.S. Pat. No. 7,631,342 to Focke, et al., entitled “Data security verification for data transfers between security levels in trusted operating systems,” each of which is incorporated by reference in its entirety.

In a preferred embodiment, guard application 64 operates in the same partition as in which electronic information is received via a communication application. Based on predetermined criteria, guard application 64 selectively either extracts a subset of data from the electronic information or blocks certain information, thereby resulting in a subset of data which is unblocked. In either case, the subset of data is then sent to another partition via unidirectional communication path 60. Once received, that subset of data may then be communicated to another entity via the communication application in the recipient partition.

It will be appreciated that based on the predetermined criteria of guard application the subset of data that is authorized for communication between partitions may include all, some, or none of the electronic data analyzed by the guard.

In another preferred embodiment, guard application 64 operates in a different partition as in which electronic information is received via a communication application. Electronic information may be communicated via a unidirectional path 60 from the partition in which it is received to the partition in which guard application 64 operates. Based on predetermined criteria, guard application 64 determines a subset of data, as discussed above. The subset of data is then sent to another partition via another unidirectional communication path 60.

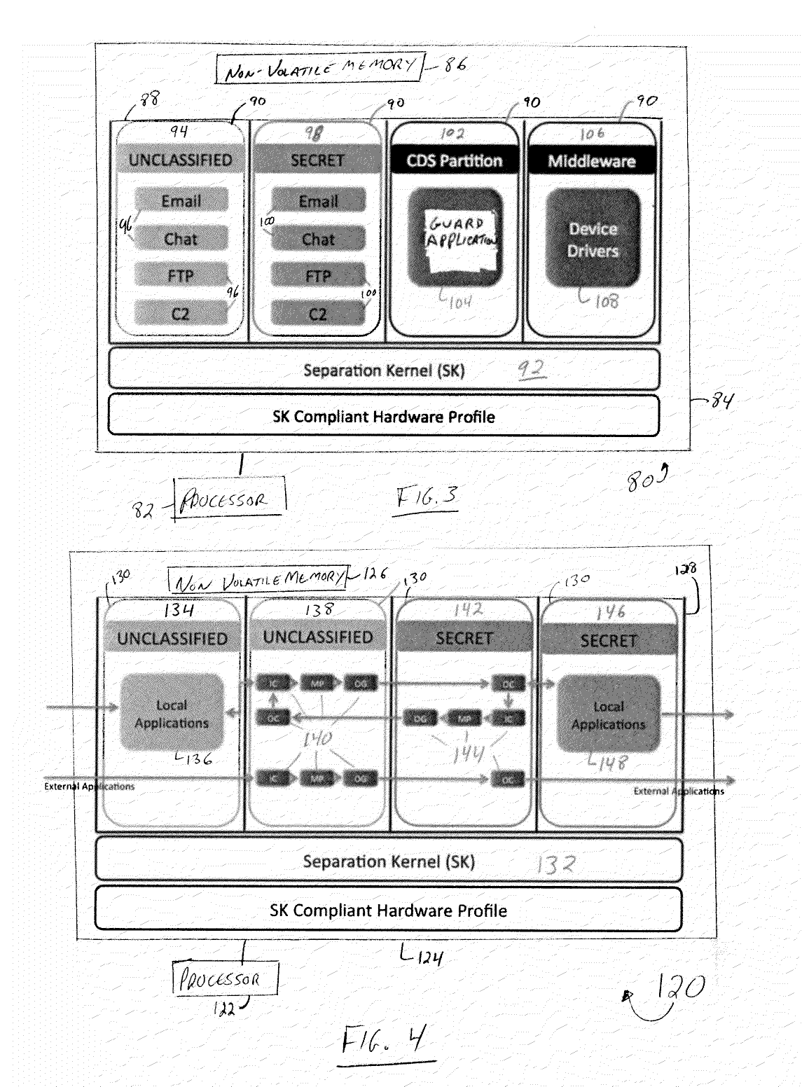

Referring now to FIG. 3, one exemplary implementation of the system of the present invention is described. System 80 includes processor 82 in communication with memory 84, which includes non-volatile memory 86 and volatile memory 88. Volatile memory 88 is divided into four partitions 90 accordingly to separation kernel 92, which also provides an operating environment in each partition. Partition 94 is assigned a classification level of UNCLASSIFIED and communication applications 96 operate in the operating environment of partition 94. Partition 98 is assigned a classification level of SECRET and communication applications 100 operate in the operating environment of partition 98. Preferably, each of partitions 94 and 98 have only end user applications operating in the respective operating environments.

Partition 102 is the guard partition, and guard application 104 operates in the operating environment of partition 102. In some embodiments, guard application may reside in a plurality of guard partitions. Partition 106 is the middleware partition, and device drivers 108 and optionally other middleware operate in the operating environment of partition 106. One optional middleware component includes an abstraction layer application which prevents detection of separation kernel 92 by guard application 104. Of course, other partitions could be included in similar embodiments, and such partitions may provide an operating environment for other communications applications associated with clearances that are higher, lower, the same as, or foreign equivalents of the clearance levels of partitions 94 or 98.

Separation kernel 92 also provides unidirectional communication paths between partitions 90. Separation kernel 92 provides at least one unidirectional path between each partition 90 such that each partition is capable of communication with every other partition. In some preferred embodiments, the unidirectional paths between classified partitions pass through guard partition 102. For example, a communication from SECRET partition 98 would follow a unidirectional path that connects SECRET partition 98 to guard partition 102 and then connects guard partition 102 to UNCLASSIFIED partition 94. Accordingly, any data communicated between SECRET partition 98 and UNCLASSIFIED partition 94 must first pass through guard partition 102 in which guard application 104 examines the communication and limits the communicated data to a subset of information that satisfies the predetermined conditions of the guard.

An example of use of system 80 includes receipt of an e-mail message through communication applications 100 of SECRET partition 98, wherein the e-mail message contains some information (such as the location of enemy troops) relevant to a warfighter lacking SECRET clearance, but also containing other information (such as the source of the knowledge of the enemy troop location) that is not appropriate or necessary to share with the warfighter. Upon receipt of the e-mail message, the e-mail message may be directly forwarded to recipient having SECRET clearance via communication applications 100 of SECRET partition 98. The e-mail message is also communicated to guard partition 102 via a unidirectional path. Guard application 104, upon receipt of the e-mail message, then analyzes the electronic data of the e-mail message to determine that data which is authorized for communication to the warfighter. The subset of information determined appropriate for communication to the warfighter is then communicated from guard partition 102 to UNCLASSIFIED partition 94, where it can then be communicated to the warfighter via the e-mail program of communication applications 96.

If the warfighter respond to the sender of the e-mail message, the response email may be received by the e-mail program of communication applications 96 and communicated to guard partition 102 for analysis by guard application 104 prior to communication to SECRET partition 98 and communication to the original sender via the e-mail program of communication applications 100. Because the electronic data of the warfigher's response e-mail is being communicated from a partition having a lower clearance level to a partition having a higher clearance level, the subset of information authorized by guard application 104 may include the entirety of the warfighter's e-mail message. Accordingly, although it is preferable to include a guard application as a non-bypassable component of all inter-partition communications, in some embodiments of the invention a unidirectional path may connect a partition having a lower clearance level to a partition having a higher clearance level which does not require communication through the guard partition or examination by the guard application.

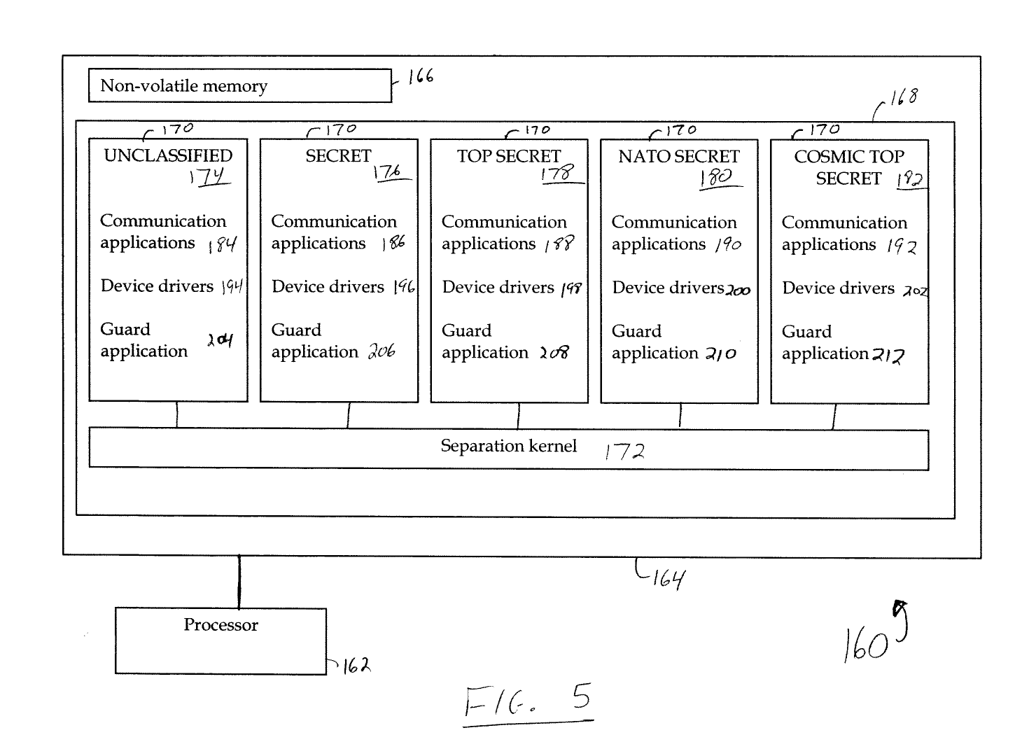

FIG. 4 depicts an alternative implementation of the system of the present invention, in which system 120 includes processor 122 in communication with memory 124, which includes non-volatile memory 126 and volatile memory 128. Volatile memory 128 is divided into four partitions 130 accordingly to separation kernel 132, which also provides an operating environment in each partition. Partition 134 is assigned a classification level of UNCLASSIFIED and local applications 136, including communication applications, operate in the operating environment of partition 134. Partition 138 is guard partition which is assigned a classification level of UNCLASSIFIED and guard application 140 operates in the operating environment of partition 138.

Partition 142 is assigned a classification level of SECRET and local applications 144, including communication applications, operate in the operating environment of partition 142. Partition 146 is guard partition which is assigned a classification level of SECRET and guard application 148 operates in the operating environment of partition 146.

Guard applications 140 and 144 may be illustratively divided into the functional components of IC (input channel), MP (message processing), OG (output guard) and OC (output channel). The IC reads data from the communications device and frames the message from the data stream. The MP parses the message into attributes, sanitizes and downgrades the data, formats the data into a new message and applies the guard rule. The OG prevents the communication of data that has not been processed by the MP. The OC writes data to the communication device. It will be appreciated that although guard applications 140 and 144 are provided separate reference numerals, they may be components of a single guard application.

In system 120, each partition in which communication applications operate at a specified clearance level is associated with a guard partition having the same clearance level, and those two partitions preferably communicate via a loopback socket. Device drivers and other middleware may operate in the same operating environment as the associated communication systems. Of course, other partitions could be included in similar embodiments, and would preferably be provided in pairs with one application partition associated with one guard partition each having the same clearance level.

Separation kernel 132 also provides communication paths between partitions 130. In some cases, the communication paths may be bidirectional, such as between partitions having the same clearance level, such as between partitions 134 and 138 or as between partitions 142 and 146. Additionally, separation kernel 132 preferably provides at least one unidirectional path between each partition 130 such that each partition is capable of communication with every other partition. In some preferred embodiments, the unidirectional paths connect the application partitions via the guard partitions. For example, SECRET application partition 146 may communicate with SECRET guard partition 142 via a communication path (that may or may not be unidirectional), which communicates with UNCLASSIFIED guard partition 138 via a unidirectional path, and then UNCLASSIFIED guard partition 138 communicates with UNCLASSIFIED application partition 134 via a communication path (that may or may not be unidirectional). Alternatively, SECRET application partition 146 may communicate with SECRET guard partition 142 via a communication path (that may or may not be unidirectional), which communicates with UNCLASSIFIED application partition 134 via a unidirectional communication path. In either scenario, any data communicated between SECRET application partition 146 and UNCLASSIFIED partition 134 must first pass through guard partition 142 in which guard application 144 examines the communication and limits the communicated data to a subset of information that satisfies the predetermined conditions of the guard.

An example of use of system 120 includes receipt of an e-mail message through a communication application of local application 148 of SECRET partition 146, wherein the e-mail message contains some information (such as the location of enemy troops) relevant to a warfighter lacking SECRET clearance, but also containing other information (such as the source of the knowledge of the enemy troop location) that is not appropriate or necessary to share with the warfighter. Upon receipt of the e-mail message, the e-mail message may be directly forwarded without sanitation to recipients having SECRET clearance via communication applications of local applications 148 of SECRET partition 146. The e-mail message is also communicated to SECRET guard partition 142. SECRET guard application 142, upon receipt of the e-mail message, analyzes the electronic data of the e-mail message to determine that data which is authorized for communication to the warfighter. The subset of information determined appropriate for communication to the warfighter is then communicated from SECRET guard partition 142 to UNCLASSIFIED guard partition 138 via a unidirectional path. The subset of information may be further reviewed by guard application 140 in UNCLASSIFIED guard partition 138. Then the subset of information is communicated to UNCLASSIFIED application partition 134, in which the sanitized information may be communicated to the warfighter via the e-mail program of the communication applications in local applications 136.

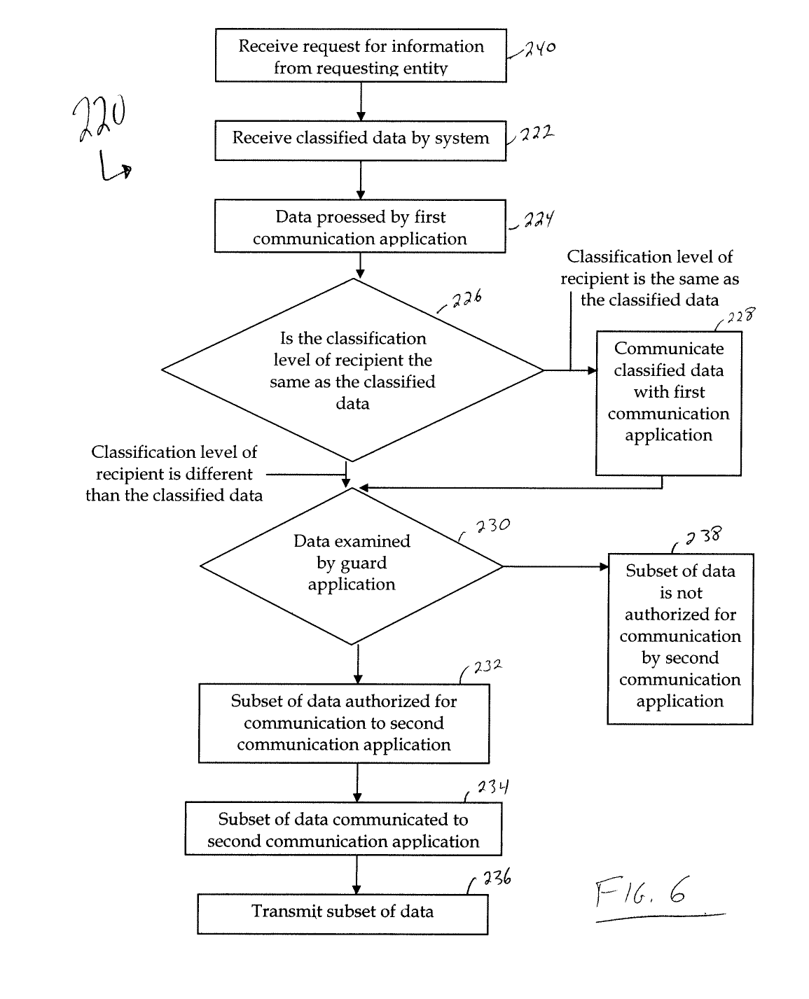

FIG. 5 depicts a further alternative implementation of the system of the present invention, in which system 160 includes processor 162 in communication with memory 164, which includes non-volatile memory 166 and volatile memory 168. Volatile memory 168 is divided into five partitions 170 accordingly to separation kernel 172, which also provides an operating environment in each partition 170.

Partitions 170 are assigned classification levels for either the United States government or for NATO. In this regard, partition 174 is assigned a classification level of UNCLASSIFIED, partition 176 is assigned a classification level of SECRET, partition 178 is assigned a classification level of TOP SECRET, partition 180 is assigned a classification level of NATO SECRET, and partition 182 is assigned a classification level of COSMIC TOP SECRET. Applications stored in the non-volatile memory operate in the operating environments provided in each partition via the security kernel 172. Particularly, operating in the operating environment of each partition is communication application 184, 186, 188, 190, or 192, device drivers 194, 196, 198, 200, or 202, guard application 204, 206, 208, 210, or 212. Of course, other end-user applications also may operate in one or more partitions, as desired. Likewise, fewer or additional partitions may be included in other embodiments.

Separation kernel 172 also provides communication paths between partitions 170. Although the communication paths may be bidirectional, such as between SECRET partition 176 and NATO SECRET partition 180, preferred embodiments include unidirectional communication paths between partitions. Additionally, separation kernel 172 preferably provides at least one unidirectional path between each partition 170 such that each partition is capable of communication with every other partition.

Partition 178 is typical of a partition in system 160, in that it has an operating system provided by separation kernel 172 in which operates communication application 188 and guard application 208. If a message is received by communication application 188 that contains electronic data desired for communication to entities that do not have TOP SECRET clearance, then guard application 208 can examine the electronic data to determine a subset of that information appropriate for communication in accordance with predefined conditions. Once the subset of data is communicated, that subset can be communicated to the applications operating in another partition via the unidirectional paths.

It should be appreciated that the guard may examine electronic data and determine a different subset of information appropriate for communication based on a number of factors. For example, the guard may determine the subset appropriate for communication based at least in part on: the classification level of the partition to which the data subset will be communicated; the identity, clearance authorization, or other characteristic of the entity from which the message originated; the identity, clearance authorization, or other characteristic of an entity communicating a request for information; and/or the identity, clearance authorization, or other characteristic of an entity identified to receive the data subset.

For example, in a battlespace environment in which U.S. and NATO forces are working together, an e-mail message may be received via communications application 188 of TOP SECRET partition 178. The message may be routed to other recipients having TOP SECRET clearance without modification via communications application 188. The message may also have information that is desirable to share with others in the battlespace, though not all of the information is appropriate for unsanitized distribution. Accordingly, guard application may examine the e-mail message and determine three subsets of information. The first subset of information may be appropriate for U.S. forces having SECRET clearance, and therefore may be communicated via a unidirectional path to SECRET partition 176, where it can be communicated via communication application 186. Likewise, the original message may contain certain information that is not appropriate to share with foreign entities. Hence, guard application 208 may determine a second subset of information appropriate to share with entities having COSMIC TOP SECRET clearance, as well as a third subset of information appropriate for sharing with entities having NATO SECRET clearance. These subsets of information may be communicated via unidirectional paths to COSMIC TOP SECRET partition 182 and NATO SECRET partition 180, respectively, where they can then be communicated via communication applications 192 and 190. As such, each recipient will receive the pertinent information as based on his or her clearance level.

It will be appreciated that while the embodiment of system 160 may have advantages related to the architecture and design of the system as compared to other embodiments of the present invention, other embodiments may be more effective in terms of computational resources in operation.

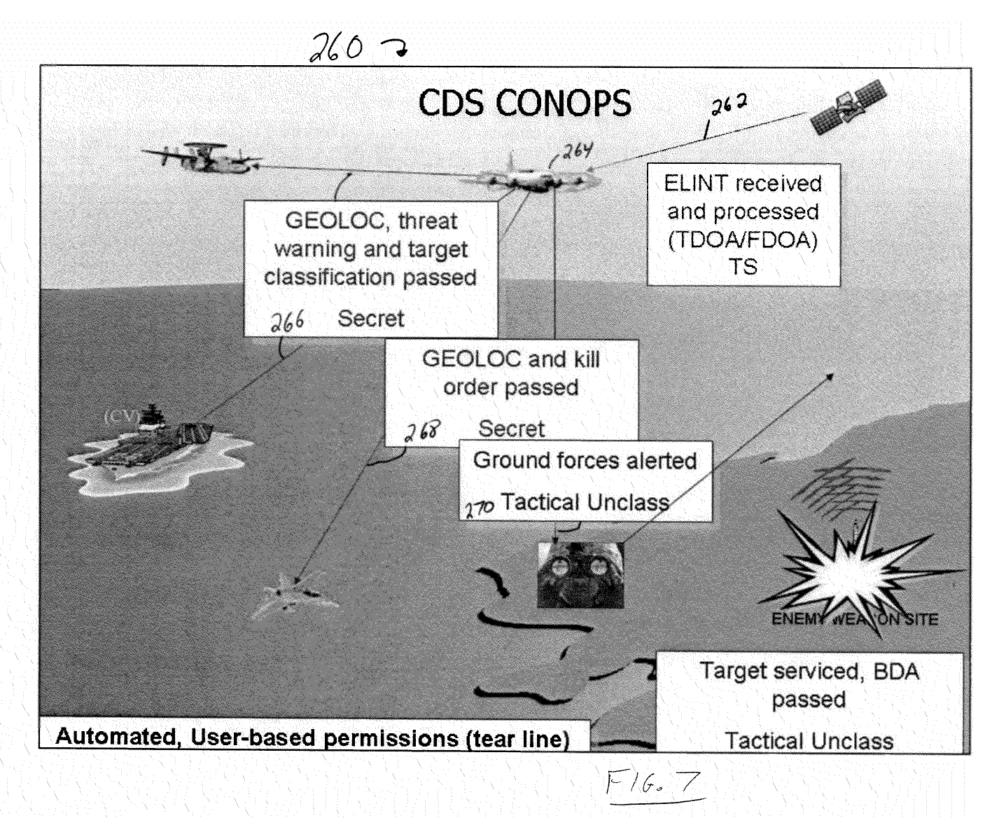

A preferred method of using the present invention is described in reference to FIG. 6. Method 220 will be described by example in conjunction with use of system 80, discussed earlier in reference to FIG. 3, but it will be appreciated that similar methods of use exist for other embodiments of systems of the present invention.

In step 222 of method 220, SECRET classified data is received by communication application 100, illustratively an e-mail application. In step 224, communication application 100 processes the SECRET classified data to determine routing instructions transmitted with the communication. Such routing instructions may include identifying recipients of an e-mail message, retransmission of an audio message over a specified frequency, or delivery of information to a data storage location.

In optional step 226, communication application 100 examines the routing instructions to determine the clearance level associated with the routing instructions. For example, if the classified data is an e-mail message, this step examines the recipients and/or domains to determine the clearance levels associated with the recipients and/or domains. If the clearance level of one or more of the recipients and/or domains is the same as the clearance level associated with communication application 100, then communication application 100 forwards or retransmits the classified data to the recipients and/or domains having the same clearance level as communication application 100 in step 228.

If there is a recipient and/or domain having a different clearance level than communication application 100 following step 228, or if optional stop 226 is not performed, the next step in system 220 is step 230. At step 230, the guard application examines the SECRET classified data to determine which information is appropriate and/or inappropriate for communication. This determination is made based on predetermined rules or criteria, which may include the identity of the recipient, the clearance level of the recipient, and/or the clearance level associated with the communication application which will communicate the data. A portion of the communication may be deemed appropriate for communication to certain recipients but not to all recipients.

In system 80, the SECRET classified data received by communication application 100 is communicated to guard application 104 via a unidirectional path created by instructions in separation kernel 92. After guard application 104 examines the SECRET classified data to determine which information is appropriate for communication, that subset of data determined appropriate for communication is authorized for communication by guard application 104 in step 232.

It will be appreciated that the subset data authorized for communication will often be less than the entirety of the SECRET classified data received by communication application 100, but in some cases (such as when the communication is to be received by a recipient having a higher clearance level) the subset of data may be the entirety of the original message, and in other cases (such as when there is no information deemed appropriate for communication) the subset of data may be an empty set, wherein no data is communicated to the recipient.

The subset of data determined appropriate for communication is authorized for communication to communication application 96 at step 232. In the event that the inventive system involves a plurality of clearance authorizations and/or if the communication is intended for a plurality of recipients, step 232 (and subsequent steps) can be repeated for each clearance level and/or each recipient. For example, if a transmission classified as TOP SECRET/SCI is received, the guard application may authorize: a first subset of data comprising the totality of the original transmission for communication to a first recipient having TOP SECRET/SCI clearance; a second subset of data comprising less then the totality of the original transmission for communication to a second recipient having TOP SECRET/SCI clearance; a third subset of data comprising less than the second data subset for communication over a channel associated with a SECRET clearance; and a fourth subset of data comprising either no information or an acknowledgment that the original transmission was sent (but withholding the specific contents of that message) for communication over a channel associated with an FOR OFFICIAL USE ONLY classification.

In step 234, a data subset that was authorized for communication is communicated to the communication application. Here, assuming a recipient does not have SECRET clearance, this step includes communication of a subset of information from guard partition 102 to UNCLASSIFIED partition 94 in system 80. In some embodiments, such as those in which optional step 226 is omitted, step 234 may include communication of the data subset back to the communication application which previously received the SECRET classified data transmission.

In step 236, the data subset is communicated by the communication application, and in this example communication application 96 sends the data subset via e-mail to a recipient.

At step 230, in the event that data is determined inappropriate for communication, the data is not authorized for communication at step 238. The data that is not authorized for communication may then be deleted, erased, overwritten, or otherwise made unavailable as part of the guard application's operation or in the normal course of operation of volatile memory 88.

Optionally, in step 240, a recipient may request information from a communication. Such a request may occur at various points in method 220, but preferably occurs prior to the receipt of the communication. Such a request may be communicated to guard application 104 and optionally may be approved in accordance with predetermined conditions programmed into guard application 104.

FIG. 7 provides an further illustrative view of the use of the present invention in the context of method 260. At step 262 a satellite communicates a TOP SECRET transmission of electronic signals intelligence (ELINT) that has been received and processed by the satellite. The TOP SECRET communication is received by an airborne platform, such as an EP-3E Aries II, at step 264. An airborne system in accordance with the present invention, system 160 for the purposes of this example, receives the TOP SECRET communication via communication applications 188. Guard application 208 determines a subset of data of the TOP SECRET communication that is appropriate for communication over a SECRET channel and authorizes that subset of data for communication, which illustratively comprises geolocation information, threat warning, and target classification. The subset of data is communicated from TOP SECRET partition 178 to SECRET partition 176 via a unidirectional channel, and then communication applications 186 communicate the subset of information to recipients at step 266.

Following transmission of a SECRET communication containing target location and authorization to attack the target (not shown) by a recipient of the data subset of step 266, the SECRET communication is received by communication application 186 and retransmitted without further sanitization to an attack aircraft at step 268. At approximately the same time, the SECRET transmission is sanitized by guard application 206 prior to communication to ground forces. In this regard, the SECRET message is received by communication application 186, examined by guard application 206 to determine the portions of the message appropriate for communication to ground forces, which is TUI in this example. That subset of information is then authorized for communication by guard application 206 and then communicated via unidirectional path to communication application 184 operating in UNCLASSIFIED partition 174. Communication application 184 transmits the TUI subset of information to ground forces, step 270, which are then able to prepare for the attack and assess the damage.

Thus is it seen that systems and methods of providing data security and communicating information are provided. While preferred illustrative embodiments of the invention are described above, it will be apparent to one skilled in the art that various changes and modifications may be made therein without departing from the invention. The appended claims are intended to cover all such changes and modifications that fall within the true spirit and scope of the invention.

What is claimed:

1. A system for managing the selective communication of electronic data comprising:
a memory device having volatile memory and non-volatile memory;
a separation kernel stored in the non-volatile memory and configured to provide:
(a) a first partition with a first classification level and a second partition with a second classification level in the volatile memory, the second classification level being lower than the first classification level, and
(b) a unidirectional communication path between the first partition and the second partition, and
(c) a first operating environment in the first partition and a second operating environment in the second partition;
a first communication application stored in the non-volatile memory and configured to operate in the first operating environment and to receive electronic data having a first data set;
a guard application stored in the non-volatile memory and configured to examine the first data set and determine a first data subset authorized for communication from the first partition to the second partition;
a processor in communication with the first partition and the second partition and configured to control communication of the first data subset from the first partition to the second partition via the unidirectional communication path; and
a second communication application configured to operate in the second operating environment and to transmit the first data subset.

2. The system of claim 1, wherein at least a portion of the guard application is configured to operate in the first operating environment.

3. The system of claim 2 further comprising a second guard application, wherein at least a portion of the second guard application is configured to operate in the second operating environment.

4. The system of claim 3 further comprising a third partition in the memory device, wherein the second communication application is further configured to receive electronic data having a second data set and the second guard application is configured to determine a second data subset authorized for communication from the second partition to the third partition.

5. The system of claim 1, wherein the memory device further comprises a third partition,
wherein the separation kernel is further configured to provide a third operating environment in the third partition, and
wherein the guard application is configured to operate in the third operating environment.

6. The system of claim 5, wherein the memory device further comprises a fourth partition,
wherein the separation kernel is further configured to provide a fourth operating environment in the fourth partition, and
wherein one or more device drivers are configured to operate in the fourth operating environment.

7. The system of claim 6 wherein the memory device further comprises a fifth partition with a third classification level.

8. A system for managing the communication of electronic data comprising:
a memory device having volatile memory and non-volatile memory;
a separation kernel stored in the memory device and configured to provide:
(a) a first partition with a first classification level in the volatile memory, a second partition with a first classification level in the volatile memory, a third partition with a second classification level in the volatile memory, and a fourth partition with second classification level in the volatile memory
(b) a unidirectional communication path between the first partition to the fourth partition, and
(c) a first operating environment in the first partition, a second operating environment in the second partition, a third operating environment in the third partition, and a fourth operating environment in the fourth partition;
a first communication application configured to operate in the first operating environment and to receive electronic data having a first data set;
a first guard application stored in the non-volatile memory and configured to examine the first data set and determine a first data subset authorized for communication from the first partition;
a second communication application configured to operate in the fourth operating environment and to receive electronic data having a second data set;
a second guard application stored in the non-volatile memory and configured to examine the second data set and determine a second data subset authorized for communication from the fourth partition; and
a processor in communication with the memory device and configured to control transfer of the first data subset from the first partition to the fourth partition via the unidirectional communication path,
wherein the second communication application is further configured to receive the first data subset.

9. The system of claim 8 wherein first guard application is configured to operate in the second operating environment and the second guard application is configured to operate in the third operating environment.

10. The system of claim 9 wherein the second classification level is higher than the first classification level.

11. A system for managing the communication of electronic data comprising a data set, the system comprising:
a memory device having volatile memory and non-volatile memory;
a separation kernel stored in the non-volatile memory and configured to provide:
(a) a first partition with a first classification level in the volatile memory and a second partition with a second classification level in the volatile memory, the second classification level being different from than the first classification level,
(b) a unidirectional communication path between the first partition and the second partition, and
(c) a first operating environment in the first partition and a second operating environment in the second partition;
a first communication application configured to operate in the first operating environment and to receive the first data set;
a guard application stored in the memory device and configured to examine the data set in response for a request for information and determine a data subset authorized for communication from the first partition to the second partition;
a processor in communication with the first partition and the second partition and configured to control transfer of the data subset from the first partition to the second partition via the unidirectional communication path; and
a second communication application configured to operate in the second operating environment and to transmit the data subset.

12. The system of claim 11 wherein the data subset is determined by the guard application based at least in part on the classification level of the second partition.

13. The system of claim 11 wherein the data subset is determined by the guard application based at least in part on a characteristic of an entity communicating the request for information.

14. The system of claim 11 wherein the data subset is determined by the guard application based at least in part on a characteristic of an entity identified to receive the data subset.

15. A method of communicating electronic data comprising a data set including a data subset, the method comprising,
providing a system as described in claim 1;
receiving electronic data having the first data set using the first communication application;
examining the first data set using the guard application;
determining the first data subset with the guard application;
authorizing communication of the data subset with the guard application; and
communicating the data subset from the first partition to the second partition.

16. The method of claim 15 wherein the step of determining the first data subset comprises determining the first data subset based at least in part on the classification level of the second partition.

17. The method of claim 15 further comprising the step of transmitting the first data subset with the second communication application.

18. The method of claim 17 further comprising the step of receiving a request for information from a requesting entity.

19. The method of claim 18 wherein the step of determining the first data subset comprises determining the first data subset based at least in part on a characteristic of the requesting entity.

20. The method of claim 19 wherein the characteristic of the requesting entity is selected based at least in part on the classification authorization of the requesting entity.
